(19) United States
(12) Patent Application Publication
(10) Pub. No.: US 2021/0122959 A1
(43) Pub. Date: Apr. 29, 2021

(54) ABRASIVE ARTICLES INCLUDING SOFT SHAPED ABRASIVE PARTICLES

(71) Applicant: 3M INNOVATIVE PROPERTIES COMPANY, St Paul, MN (US)

(72) Inventors: Scott M. Mevissen, White Bear Lake, MN (US); Mark A. Lukowski, St. Paul, MN (US); Thomas J. Nelson, Woodbury, MN (US); Kaylee R. Schmall, Minneapolis, MN (US); Myhanh T. Truong, Cottage Grove, MN (US)

(21) Appl. No.: 17/054,182

(22) PCT Filed: May 6, 2019
(86) PCT No.: PCT/IB2019/053673

§ 371 Date: Nov. 10, 2020

Related U.S. Application Data
(60) Provisional application No. 62/669,568, filed on May 10, 2018.

(51) Int. Cl. C09K 3/14; C08K 3/36; C08K 3/26; C08K 3/04; C08K 3/34; B24D 13/14

(52) U.S. Cl. CPC C09K 3/1409; C08K 3/36; C08K 3/26; C08K 3/04; C08K 2003/265; B24D 13/147; C08K 2201/005; C08K 2003/343; C08K 3/346

(57) ABSTRACT

The present disclosure provides an abrasive article. The abrasive article includes a base. The abrasive article further includes a plurality of soft shaped abrasive particles distributed about the base.

### BACKGROUND

Abrasive articles such as abrasive belts, abrasive sheets, and abrasive wheels can be used to abrade a workpiece. However, some workpieces are composed of multiple materials. Typical abrasive articles are not capable of selectively abrading a single material of the workpiece. There is therefore a need to develop abrasive articles that can selectively abrade materials of a workpiece.

### SUMMARY OF THE DISCLOSURE

The present disclosure provides an abrasive article. The abrasive article includes a base. The abrasive article further includes a plurality of soft shaped abrasive particles distributed about the base.

The present disclosure further provides a method of using an abrasive article. The abrasive article includes a base. The abrasive article further includes a plurality of soft shaped abrasive particles distributed about the base. The method includes contacting the abrasive article with a workpiece. The method further includes moving at least one of the workpiece and the abrasive article relative to one another.

The present disclosure further provides a method of making an abrasive article. The abrasive article includes a base. The abrasive article further includes a plurality of soft shaped abrasive particles distributed about the base. The method includes selecting soft shaped abrasive particles having a hardness of a predetermined value. The method further includes distributing the soft shaped abrasive particles about the base.

There are several non-limiting advantages to using the abrasive articles described herein, some of which are unexpected. For example, according to some embodiments the soft shaped abrasive particles can be selected to abrade a first material in a workpiece to a greater degree than a second material of the workpiece. Thus, according to some embodiments, abrasive articles including the disclosed abrasive particles can be used to selectively abrade a workpiece including multiple materials. According to some embodiments, the soft shaped abrasive particles can be easily incorporated into a wide variety of abrasive articles that can be suited for many abrading operations. According to some embodiments, the soft shaped abrasive particles, can be precisely oriented in the abrasive article to tune the abrasive performance of the abrasive article. According to some embodiments, the materials that are included in the soft abrasive particles are not likely to cause a spark during use, thus lowering the risk of fires or explosions when used during an abrasion process.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1A is a top view of a soft shaped abrasive particle, in accordance with various embodiments.

FIG. 1B is a side view of the soft abrasive particle of FIG. 1A, in accordance with various embodiments.

FIG. 2A is a perspective view of a soft abrasive particle, in accordance with various embodiments.

FIG. 2B is a perspective view of a soft abrasive particle, in accordance with various embodiments.

FIG. 2C is a perspective view of a soft abrasive particle, in accordance with various embodiments.

FIG. 2D is a perspective view of a soft abrasive particle, in accordance with various embodiments.

FIG. 2E is a perspective view of a soft abrasive particle, in accordance with various embodiments.

FIG. 3 is a sectional view of a coated abrasive article including soft shaped abrasive particles, in accordance with various embodiments.

FIG. 4A is a perspective view of a bonded abrasive article including soft shaped abrasive particles, in accordance with various embodiments.

FIG. 4B is a sectional view of the bonded abrasive article of FIG. 4A, in accordance with various embodiments.

FIG. 5A is a perspective view of a fibrous abrasive article including soft shaped abrasive particles, in accordance with various embodiments.

FIG. 5B is a sectional view of the fibrous abrasive article of FIG. 5A, in accordance with various embodiments.

FIG. 6 is a sectional view of a composite abrasive article including soft shaped abrasive particles, in accordance with various embodiments.

FIG. 7 is a photograph of a fibrous abrasive article described in Example 1, in accordance with various embodiments.

FIG. 8 is a photograph of the fibrous abrasive article of FIG. 7 at 20× magnification, in accordance with various embodiments.

FIG. 9 is a photograph of the fibrous abrasive article of FIG. 7 at 50× magnification, in accordance with various embodiments.

FIG. 10 is a photograph of a fibrous abrasive article described in Example 2, in accordance with various embodiments.

FIG. 11 is a photograph of the fibrous abrasive article of FIG. 10 at 20× magnification, in accordance with various embodiments.

FIG. 12 is a photograph of the fibrous abrasive article of FIG. 10 at 50× magnification, in accordance with various embodiments.

FIG. 13 is a photograph of a fibrous abrasive article described in Example 3, in accordance with various embodiments.

FIG. 14 is a photograph of the fibrous abrasive article of FIG. 13 at 20× magnification, in accordance with various embodiments.

FIG. 15 is a photograph of the fibrous abrasive article of FIG. 13 at 50× magnification, in accordance with various embodiments.

FIG. 16 is a photograph of a bonded abrasive article described in Example 4, in accordance with various embodiments.

FIG. 17 is a photograph of the bonded abrasive article of FIG. 16 at 20X, in accordance with various embodiments.

FIG. 18 is a photograph of the reticulated polyurethane foam based abrasive article described in Example 5, in accordance with various embodiments.

FIG. 19 is a photograph of the open cell polyurethane foam based abrasive article described in Example 6, in accordance with various embodiments.

FIG. 20 is a photograph of the lofty nonwoven web based abrasive article of Example 7, in accordance with various embodiments.

FIG. 21 is a photograph of a soft shaped abrasive particle produced according to Example 8, in accordance with various embodiments.

FIG. 22 is a photograph of a plurality of the shaped abrasive particles according to Example 8 disposed in tool cavities, in accordance with various embodiments.

FIG. 23 is a photograph of a soft shaped abrasive particle produced according to Example 9, in accordance with various embodiments.

FIG. 24 is a photograph of a plurality of the shaped abrasive particles according to Example 9 disposed in tool cavities, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “shaped abrasive particles” as used herein refers to any abrasive particle with at least a portion of the abrasive particle having a predetermined shape. The predetermined shape can be replicated, for example, from a mold cavity that is used to form a shaped precursors abrasive particle. In embodiments where the shaped abrasive particles are formed in mold cavity, the predetermined geometric shape may substantially replicate the mold cavity used to form the shaped abrasive particle. Shaped abrasive particles may also replicate a shape of a die in examples where a shaped abrasive particle is formed through extrusion. Shaped abrasive particles may also replicate a shape found in a program, for example a computer-aided-design (CAD) program, if shaped abrasive particles or the abrasive article is formed through an additive manufacturing process. Shaped abrasive particles do not refer to randomly sized crushed abrasive particles formed, for example, by a mechanical crushing operation.

The term, “z-direction rotational orientation” refers to a soft shaped abrasive or ceramic shaped abrasive particle's angular rotation about a z-axis passing through the particle and through a base at a 90 degree angle to the backing when the particle is attached to the backing.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

According to various embodiments of the present disclosure, an abrasive article including a base and a plurality of soft shaped abrasive particles distributed about the base is described. The plurality of soft shaped abrasive particles can be distributed on a surface of the base or throughout the volume of the base. For example, the plurality of soft shaped abrasive particles can be distributed over about 10% to about 95% surface area or volume of a first side of the base, about 10% to about 50%, or about 10%, 15, 20, 25, 30, 35, 40, 45, 50, 55, 60, 65, 70, 75, 80, 85, 90, or about 95%. The soft shaped abrasive particles can be randomly distributed about the base or according to a predetermined pattern.

The soft shaped abrasive particles described herein can include any suitable material or combination of materials. For example, the soft shaped abrasive particles can include a reaction product of a polymerizable mixture including one or more polymerizable resins. The one or more polymerizable resins are chosen from a phenolic resin, a urea formaldehyde resin, a urethane resin, a melamine resin, an epoxy resin, a bismaleimide resin, a vinyl ether resin, an aminoplast resin (which may include pendant alpha, beta unsaturated carbonyl groups), an acrylate resin, an acrylated isocyanurate resin, an isocyanurate resin, an acrylated urethane resin, an acrylated epoxy resin, an alkyd resin, a polyester resin, a drying oil, or mixtures thereof. The polymerizable mixture can include additional components such as a plasticizer, an acid catalyst, a cross-linker, a surfactant, a mild-abrasive, a pigment, a catalyst and an antibacterial agent.

Where multiple components are present in the polymerizable mixture, those components can account for any suitable weight percentage (wt %) of the mixture. For example, the polymerizable resin or resins, may be in a range of from about 35 wt % to about 99.9 wt % of the polymerizable mixture, about 40 wt % to about 95 wt %, or less than, equal to, or greater than about 35 wt %, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or about 99.9 wt %.

If present, the cross-linker may be in a range of from about 2 wt % to about 60 wt % of the polymerizable mixture, from about 5 wt % to about 10 wt %, or less than, equal to, or greater than about 2 wt %, 3, 4, 5, 6, 7, 8, 9, 10, 11, 12, 13, 14, or about 15 wt %. Examples of suitable cross-linkers include a cross-linker available under the trade designation CYMEL 303 LF, of Allnex USA Inc., Alpharetta, Ga., USA; or a cross-linker available under the trade designation CYMEL 385, of Allnex USA Inc., Alpharetta, Ga., USA.

If present the mild-abrasive may be in a range of from about 5 wt % to about 65 wt % of the polymerizable mixture, about 10 wt % to about 20 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or about 65 wt %. Examples of suitable mild-abrasives include a mild-abrasive available under the trade designation MINSTRON 353 TALC, of Imerys Talc America, Inc., Three Forks, Mont., USA; a mild-abrasive available under the trade designation USG TERRA ALBA NO.1 CALCIUM SULFATE, of USG Corporation, Chicago, Ill., USA; Recycled Glass (40-70 Grit) available from ESCA Industries, Ltd., Hatfield, Pa., USA, silica, calcite, nepheline, syenite, calcium carbonate, or mixtures thereof.

If present, the plasticizer may be in a range of from about 5 wt % to about 40 wt % of the polymerizable mixture, about 10 wt % to about 15 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or about 40 wt %. Examples of suitable plasticizers include acrylic resins or styrene butadiene resins. Examples of acrylic resins include an acrylic resin available under the trade designation RHOPLEX GL-618, of DOW Chemical Company, Midland, Mich., USA; an acrylic resin available under the trade designation HYCAR 2679, of the Lubrizol Corporation, Wickliffe, Ohio, USA; an acrylic resin available under the trade designation HYCAR 26796, of the Lubrizol Corporation, Wickliffe, Ohio, USA; a polyether polyol available under the trade designation ARCOL LG-650, of DOW Chemical Company, Midland, Mich., USA; or an acrylic resin available under the trade designation HYCAR 26315, of the Lubrizol Corporation, Wickliffe, Ohio, USA. An example of a styrene butadiene resin includes a resin available under the trade designation ROVENE 5900, of Mallard Creek Polymers, Inc., Charlotte, N.C., USA.

If present, the acid catalyst may be in a range of from 1 wt % to about 20 wt % of the polymerizable mixture, about 5 wt % to about 10 wt %, or less than, equal to, or greater than about 1 wt %, 2, 3, 4, 5, 6, 7, 8, 9, 10, 11, 12, 13, 14, 15, 16, 17, 18, 19, or about 20 wt %. Examples of suitable acid catalysts include a solution of aluminum chloride or a solution of ammonium chloride.

If present, the surfactant can be in a range of from about 0.001 wt % to about 15 wt % of the polymerizable mixture about 5 wt % to about 10 wt %, less than, equal to, or greater than about 0.001 wt %, 0.01, 0.5, 1, 2, 3, 4, 5, 6, 7, 8, 9, 10, 11, 12, 13, 14, or about 15 wt %. Examples of suitable surfactants include a surfactant available under the trade designation GEMTEX SC-85-P, of Innospec Performance Chemicals, Salisbury, N.C., USA; a surfactant available under the trade designation DYNOL 604, of Air Products and Chemicals, Inc., Allentown, Pa., USA; a surfactant available under the trade designation ACRYSOL RM-8W, of DOW Chemical Company, Midland, Mich., USA; or a surfactant available under the trade designation XIAMETER AFE 1520, of DOW Chemical Company, Midland, Mich., USA.

If present, the antimicrobial agent may be in a range of from 0.5 wt % to about 20 wt % of the polymerizable mixture, about 10 wt % to about 15 wt %, or less than, equal to, or greater than about 0.5 wt %, 1, 2, 3, 4, 5, 6, 7, 8, 9, 10, 11, 12, 13, 14, 15, 16, 17, 18, 19, or about 20 wt %. An example of a suitable antimicrobial agent includes zinc pyrithione.

If present, the pigment may be in a range of from about 0.1 wt % to about 10 wt % of the polymerizable mixture, about 3 wt % to about 5 wt %, or less than, equal to, or greater than about 0.1 wt %, 0.2, 0.4, 0.6, 0.8, 1, 1.5, 2, 2.5, 3, 3.5, 4, 4.5, 5, 5.5, 6, 6.5, 7, 7.5, 8, 8.5, 9, 9.5, or about 10 wt %. Examples of suitable pigments include a pigment dispersion available under the trade designation SUNSPERSE BLUE 15, of Sun Chemical Corporation, Parsippany, N.J., USA; a pigment dispersion available under the trade designation SUNSPERSE VIOLET 23, of Sun Chemical Corporation, Parsippany, N.J., USA; a pigment dispersion available under the trade designation SUN BLACK, of Sun Chemical Corporation, Parsippany, N.J., USA; or a pigment dispersion available under the trade designation BLUE PIGMENT B2G, of Clariant Ltd., Charlotte, N.C., USA.

The abrasive articles described herein can include abrasive particles in addition to soft shaped abrasive particles. For example, the abrasive articles can include a plurality of ceramic shaped abrasive particles. The ceramic shaped abrasive particles may independently include fused aluminum oxide, heat treated aluminum oxide, ceramic aluminum oxide, sintered aluminum oxide, silicon carbide, titanium diboride, boron carbide, tungsten carbide, titanium carbide, diamond, cubic boron nitride, garnet, fused alumina-zirconia, cerium oxide, zirconium oxide, titanium oxide, or a combination thereof.

The abrasive articles described herein may further include a plurality of soft crushed abrasive particles or ceramic crushed abrasive particles. Where there are blends of different types of abrasive particles, the soft shaped abrasive particles can account for any percentage of the blend. For example, the soft shaped abrasive particles can account for about 2 wt % to about 99.9 wt % of the blend, about 10 wt % to about 60 wt %, or less than, equal to, or greater than about 2 wt %, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 99.9 wt %.

Any of the individual soft shaped particles can include the same material or materials as any individual soft crushed abrasive particle. Similarly, any individual ceramic shaped abrasive particle can include the same material or materials as any ceramic crushed abrasive particle.

Although soft shaped abrasive particles or soft crushed abrasive particles differ from ceramic shaped abrasive particles or ceramic crushed abrasive particles by composition, they can also be differentiated by hardness. For example, a Mohs hardness of any individual soft shaped abrasive particle or soft crushed abrasive particle may be less than about 9, less than about 8, less than about 7, less than about 6, less than about 5, less than about 4, less than about 3, less than about 2, less than about 1, or in a range of from about 1 to about 9, or about 3 to about 7. The hardness of an individual soft shaped abrasive particle or soft crushed abrasive particle may be less than that of any individual ceramic shaped abrasive particle or ceramic crushed abrasive particle. For example, a Mohs hardness of an individual ceramic shaped abrasive particle or ceramic crushed abrasive particle may equal to or greater than alpha alumina. This can correlate to a Mohs hardness value of at least 9 or at least 10, or in a range of from about 9 to about 10. In some embodiments, a difference in Mohs hardness of an individual soft shaped abrasive particle or soft crushed abrasive particle and an individual ceramic shaped abrasive particle or ceramic crushed abrasive particle may be in a range of from about 1 to about 9, about 2 to about 5, or less than, equal to, or greater than about 1, 2, 3, 4, 5, 6, 7, 8, or about 9. Although the hardness values described herein are described in conjunction with an individual abrasive particle, those values can represent an average hardness value of respective pluralities of soft shaped abrasive particles, soft crushed abrasive particles, ceramic shaped abrasive particles, or ceramic crushed abrasive particles.

In addition to, or instead of, evaluating the hardness of soft shaped abrasive particles or soft crushed abrasive particles versus ceramic shaped abrasive particles or ceramic crushed abrasive particles using Mohs hardness, particles can be evaluated using nanoindentation procedures. For example, a soft shaped abrasive particle and a corresponding ceramic shaped abrasive particle having substantially the same dimensions can be subjected to a nanoindentation test according to ISO Standard 14577. Alternatively, a soft crushed abrasive particle and a ceramic crushed abrasive particle having substantially the same grade can be subjected to a nanoindentation test according to ISO Standard 14577. In each case, the soft shaped abrasive particle and the soft crushed abrasive particle will have a lower hardness than the corresponding ceramic shaped abrasive particle and ceramic crushed abrasive particle.

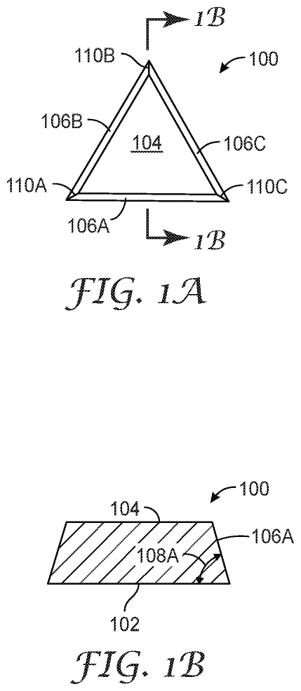

As described herein, shaped abrasive particles differ from crushed abrasive particles in that shaped abrasive particles, whether soft or ceramic, include a replicated shape. The shape can any suitable shape three-dimensional shape such as a pyramid, cone, block, cube, sphere, cylinder, rod, triangle, hexagon, square, and the like. FIGS. 1A and 1B show an example of soft shaped abrasive particle 100, as an equilateral triangle conforming to a truncated pyramid. As shown in FIGS. 1A and 1B soft shaped abrasive particle 100 includes a truncated regular triangular pyramid bounded by a triangular base 102, a triangular top 104, and plurality of sloping sides 106A, 106B, 106C connecting triangular base 102 (shown as equilateral although scalene, obtuse, isosceles, and right triangles are possible) and triangular top 104. Slope angle 108A is the dihedral angle formed by the intersection of side 106A with triangular base 102. Similarly, slope angles 108B and 108C (both not shown) correspond to the dihedral angles formed by the respective intersections of sides 106B and 106C with triangular base 102. In the case of shaped abrasive particle 100, all of the slope angles have equal value. In some embodiments, side edges 110A, 110B, and 110C have an average radius of curvature in a range of from about 0.5 μm to about 80 μm, about 10 μm to about 60 μm, or less than, equal to, or greater than about 0.5 μm, 5, 10, 15, 20, 25, 30, 35, 40, 45, 50, 55, 60, 65, 70, 75, or about 80 μm.

In the embodiment shown in FIGS. 1A and 1B, sides 106A, 106B, and 106C have equal dimensions and form dihedral angles with the triangular base 102 of about 82 degrees (corresponding to a slope angle of 82 degrees). However, it will be recognized that other dihedral angles (including 90 degrees) may also be used. For example, the dihedral angle between the base and each of the sides may independently range from 45 to 90 degrees (for example, from 70 to 90 degrees, or from 75 to 85 degrees). Edges connecting sides 106, base 102, and top 104 can have any suitable length. For example, a length of the edges may be in a range of from about 0.5 μm to about 2000 μm, about 150 μm to about 200 μm, or less than, equal to, or greater than about 0.5 μm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 μm.

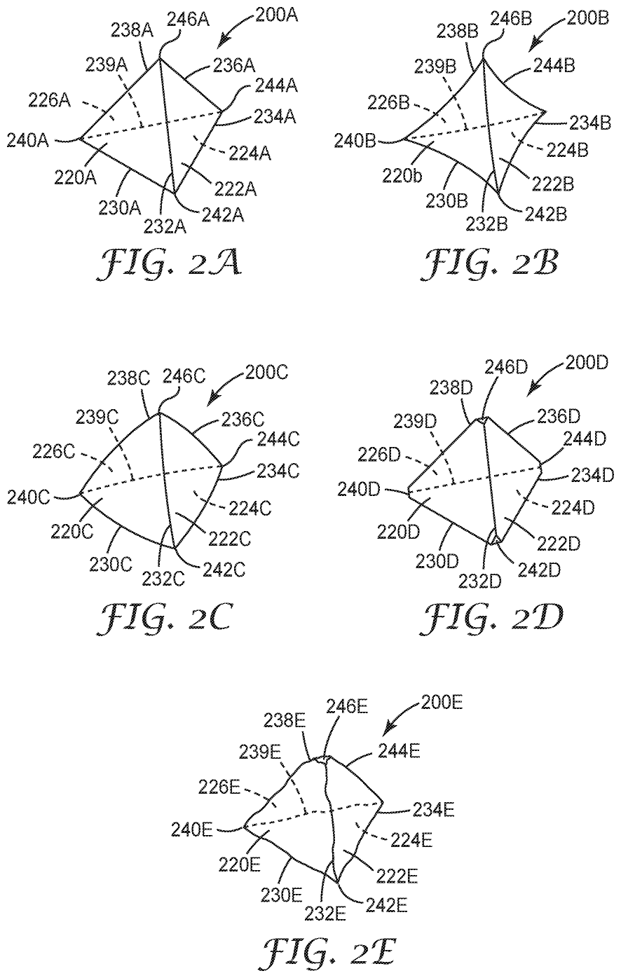

FIGS. 2A-2E are perspective views of the soft shaped abrasive particles 200 shaped as tetrahedral abrasive particles. As shown in FIGS. 2A-2E, soft shaped abrasive particles 200 are shaped as regular tetrahedrons. As shown in FIG. 2A, soft shaped abrasive particle 200A has four faces (220A, 222A, 224A, and 226A) joined by six edges (230A, 232A, 234A, 236A, 238A, and 239A) terminating at four vertices (240A, 242A, 244A, and 246A). Each of the faces contacts the other three of the faces at the edges. While a regular tetrahedron (e.g., having six equal edges and four faces) is depicted in FIG. 2A, it will be recognized that other shapes are also permissible. For example, tetrahedral abrasive particles 200 can be shaped as irregular tetrahedrons (e.g., having edges of differing lengths).

Referring now to FIG. 2B, soft shaped abrasive particle 200B has four faces (220B, 222B, 224B, and 226B) joined by six edges (230B, 232B, 234B, 236B, 238B, and 239B) terminating at four vertices (240B, 242B, 244B, and 246B). Each of the faces is concave and contacts the other three of the faces at respective common edges. While a particle with tetrahedral symmetry (e.g., four rotational axes of threefold symmetry and six reflective planes of symmetry) is depicted in FIG. 2B, it will be recognized that other shapes are also permissible. For example, soft shaped abrasive particles 200B can have one, two, or three concave faces with the remainder being planar.

Referring now to FIG. 2C, soft shaped abrasive particle 200C has four faces (220C, 222C, 224C, and 226C) joined by six edges (230C, 232C, 234C, 236C, 238C, and 239C) terminating at four vertices (240C, 242C, 244C, and 246C). Each of the faces is convex and contacts the other three of the faces at respective common edges. While a particle with tetrahedral symmetry is depicted in FIG. 2C, it will be recognized that other shapes are also permissible. For example, soft shaped abrasive particles 200C can have one, two, or three convex faces with the remainder being planar or concave.

Referring now to FIG. 2D, soft shaped abrasive particle 200D has four faces (220D, 222D, 224D, and 226D) joined by six edges (230D, 232D, 234D, 236D, 238D, and 239D) terminating at four vertices (240D, 242D, 244D, and 246D). While a particle with tetrahedral symmetry is depicted in FIG. 2D, it will be recognized that other shapes are also permissible. For example, soft shaped abrasive particles 200D can have one, two, or three convex faces with the remainder being planar.

Deviations from the depictions in FIGS. 2A-2D can be present. An example of such a soft shaped abrasive particle 200 is depicted in FIG. 2E, showing soft shaped abrasive particle 200E, which has four faces (220E, 222E, 224E, and 226E) joined by six edges (230E, 232E, 234E, 236E, 238E, and 239E) terminating at four vertices (240E, 242E, 244E, and 246E). Each of the faces contacts the other three of the faces at respective common edges. Each of the faces, edges, and vertices has an irregular shape.

In any of soft shaped abrasive particles 200A-200E, the edges can have the same length or different lengths. The length of any of the edges can be any suitable length. As an example, the length of the edges can be in a range of from about 0.5 μm to about 2000 μm, about 150 μm to about 200 μm, or less than, equal to, or greater than about 0.5 μm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 μm. Soft shaped abrasive particles 200A-200E can be the same size or different sizes.

Any one of soft shaped abrasive particles 100 or 200A-200E can include a surface feature such as a substantially planar surface; a substantially planar surface having a triangular, rectangular, hexagonal, or polygonal perimeter; a concave surface; a convex surface; an aperture; a ridge; a line or a plurality of lines; a protrusion; a point; or a depression. The surface feature can be chosen to change the cut rate, reduce wear of the formed abrasive particles, or change the resulting finish of the abrasive article.

Soft shaped abrasive particles 100 or 200A-200E, can include many additional features. For example, soft shaped abrasive particles 100 or 200A-200E can include any shape feature such as an opening, a concave surface, a convex surface, a groove, a ridge, a fractured surface, a low roundness factor, or a perimeter comprising one or more corner points having a sharp tip. Additionally, any of soft shaped abrasive particles 100 or 200A-200E, can include an opening such as a through hole, cavity, or recess.

Any of the soft shaped abrasive particles, soft crushed abrasive particles, ceramic shaped abrasive particles, or ceramic crushed abrasive particles, can be independently sized according to an abrasives industry recognized specified nominal grade. Abrasive industry recognized grading standards include those promulgated by ANSI (American National Standards Institute), FEPA (Federation of European Producers of Abrasives), and JIS (Japanese Industrial Standard). ANSI grade designations (e.g., specified nominal grades) include, for example: ANSI 4, ANSI 6, ANSI 8, ANSI 16, ANSI 24, ANSI 36, ANSI 46, ANSI 54, ANSI 60, ANSI 70, ANSI 80, ANSI 90, ANSI 100, ANSI 120, ANSI 150, ANSI 180, ANSI 220, ANSI 240, ANSI 280, ANSI 320, ANSI 360, ANSI 400, and ANSI 600. FEPA grade designations include F4, F5, F6, F7, F8, F10, F12, F14, F16, F18, F20, F22, F24, F30, F36, F40, F46, F54, F60, F70, F80, F90, F100, F120, F150, F180, F220, F230, F240, F280, F320, F360, F400, F500, F600, F800, F1000, F1200, F1500, and F2000. JIS grade designations include JIS8, JIS12, JIS16, JIS24, JIS36, JIS46, JIS54, JIS60, JIS80, JIS100, JIS150, JIS180, JIS220, JIS240, JIS280, JIS320, JIS360, JIS400, JIS600, JIS800, JIS1000, JIS1500, JIS2500, JIS4000, JIS6000, JIS8000, and JIS10,000.

Soft shaped abrasive particles 100 or 200A-200E, can be included in many different types of abrasive articles. For example, soft shaped abrasive particles 100 or 200A-200E, can be included in a coated abrasive article, a bonded abrasive article, a fibrous abrasive article, a composite abrasive article.

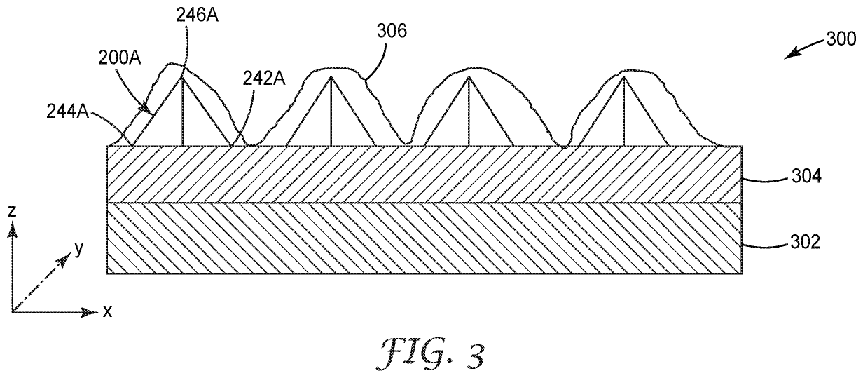

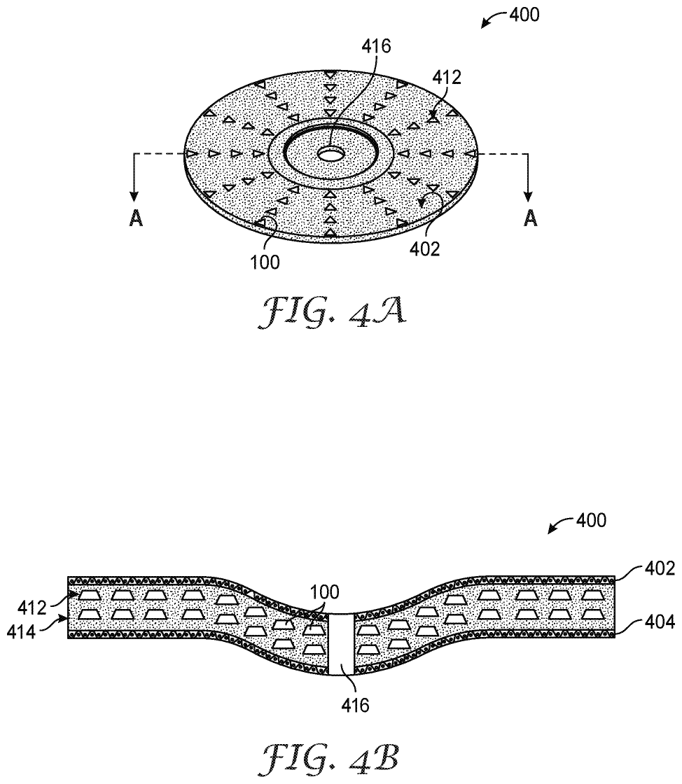

FIG. 3 is a sectional view of coated abrasive article 300. Coated abrasive article 300 includes backing 302 defining a surface along an x-y direction. Backing 302 has a first layer of binder, hereinafter referred to as make coat 304, applied over a first surface of backing 302. Attached or partially embedded in make coat 304 are a plurality of soft shaped abrasive particles 200A. Although soft shaped abrasive particles 200A are shown any other soft shaped abrasive particle described herein can be included in coated abrasive article 300. An optional second layer of binder, hereinafter referred to as size coat 306, is dispersed over soft shaped abrasive particles 200A. As shown, a major portion of soft shaped abrasive particles 200A have at least one of three vertices (240, 242, and 244) oriented in substantially the same direction. Thus, soft shaped abrasive particles 200A are oriented according to a non-random distribution, although in other embodiments any of soft shaped abrasive particles 200A can be randomly oriented on backing 302. In some embodiments, control of a particle's orientation can increase the cut of the abrasive article.

Backing 302 can be flexible or rigid. Examples of suitable materials for forming a flexible backing include a polymeric film, a metal foil, a woven fabric, a knitted fabric, paper, vulcanized fiber, a staple fiber, a continuous fiber, a nonwoven, a foam, a screen, a laminate, and combinations thereof. Backing 302 can be shaped to allow coated abrasive article 300 to be in the form of sheets, discs, belts, pads, or rolls. In some embodiments, backing 302 can be sufficiently flexible to allow coated abrasive article 300 to be formed into a loop to make an abrasive belt that can be run on suitable grinding equipment.

Make coat 304 secures soft shaped abrasive particles 200A to backing 302, and size coat 306 can help to reinforce soft shaped abrasive particles 200A. Make coat 304 and/or size coat 306 can include a resinous adhesive. The resinous adhesive can include one or more resins chosen from a phenolic resin, an epoxy resin, a urea-formaldehyde resin, an acrylate resin, an aminoplast resin, a melamine resin, an acrylated epoxy resin, a urethane resin, a polyester resin, a dying oil, and mixtures thereof.

FIGS. 4A and 4B show an example of bonded abrasive article 400. Specifically, FIG. 4A is a perspective view of bonded abrasive article 400 and FIG. 4B is a sectional view of bonded abrasive article 400 taken along line A-A of FIG. 4A. FIGS. 4A and 4B show many of the same features and are discussed concurrently. As depicted, bonded abrasive article 400 is a depressed center grinding wheel. In other examples, the bonded abrasive article can be a cut-off wheel, cutting wheel, a cut-and-grind wheel, a depressed center cut-off wheel, a reel grinding wheel, a mounted point, a tool grinding wheel, a roll grinding wheel, a hot-pressed grinding wheel, a face grinding wheel, a rail grinding wheel, a grinding cone, a grinding plug, a cup grinding wheel, a gear grinding wheel, a centerless grinding wheel, a cylindrical grinding wheel, an inner diameter grinding wheel, an outer diameter grinding wheel, and a double disk grinding wheel. The dimensions of the wheel can be any suitable size for example the diameter can range from 2 cm to about 2000 cm, about 500 cm to about 1000 cm, or less than, equal to, or greater than about 2 cm, 50, 100, 200, 300, 400, 500, 600, 700, 800, 900, 1000, 1100, 1200, 1300, 1400, 1500, 1600, 1700, 1800, 1900, or about 2000 cm.

Bonded abrasive article 400 includes first major surface 402 and second major surface 404. The first major surface and the second major surface have a substantially circular profile. Central aperture 416 extends between first major surface 402 and second major surface 404 and can be used, for example, for attachment to a power driven tool. In examples of other abrasive articles, central aperture 416 can be designed to only extend partially between first and second major surfaces 402 and 404. Bonded abrasive article 400 can be formed from a number of different components. For example, bonded abrasive article 400 can include soft shaped abrasive particles 100, diluent smaller sized soft shaped abrasive particles, soft crushed abrasive particles, super abrasive particles (e.g., diamond or cubic boron nitride), filler particles, or a combination thereof. Although soft shaped abrasive particles 100 are shown other embodiments of bonded abrasive article 400 can include soft shaped abrasive particles 200A-200E. The particles present in bonded abrasive article 400 are retained in a binder. As described herein the binder can be an organic resin. In some examples, the binder can include abrasive particles distributed therein.

Soft shaped abrasive particles 100 can be arranged in a plurality of layers. For example, as shown in FIGS. 4A and 4B bonded abrasive article 400 includes first layer of soft shaped abrasive particles 412 and second layer of soft shaped abrasive particles 414. First layer of soft shaped abrasive particles 412 and the second layer of soft shaped abrasive particles 414 are spaced apart from one another with the binder located therebetween. Although two layers are shown, bonded abrasive article 400 can include additional layers of soft shaped abrasive particles 100. For example, bonded abrasive article 400 can include a third layer of soft shaped abrasive particles 100 adjacent to at least one of the first or second layers of soft triangular abrasive particles 412 and 414. Any of layers 412 and 414 can include soft crushed abrasive particles, ceramic crushed abrasive particles, or ceramic shaped abrasive particles.

Although soft shaped abrasive particles 100, can be randomly distributed it is also possible to distribute soft shaped abrasive particles 100 according to a predetermined pattern. For example, FIG. 4A shows a pattern where adjacent soft shaped abrasive particles 100 of first layer 412 are directly aligned with each other in rows extending from central aperture 416 to the perimeter of bonded abrasive article 400. Adjacent soft shaped abrasive particles 100 are also directly aligned in concentric circles. Alternatively, adjacent soft shaped abrasive particles 100 can be staggered with respect to each other. Additional predetermined patterns of soft shaped abrasive particles 100 are also within the scope of this disclosure. For example, soft shaped abrasive particles 100 can be arranged in a pattern that forms a word or image. Soft shaped abrasive particles 100 can also be arranged in a pattern that forms an image when bonded abrasive article 400 is rotated at a predetermined speed. In addition to, or instead of, soft shaped abrasive particles 100 being arranged in a predetermined pattern, other particles such as filler particles can also be arranged in a predetermined pattern as described with respect to the abrasive particles.

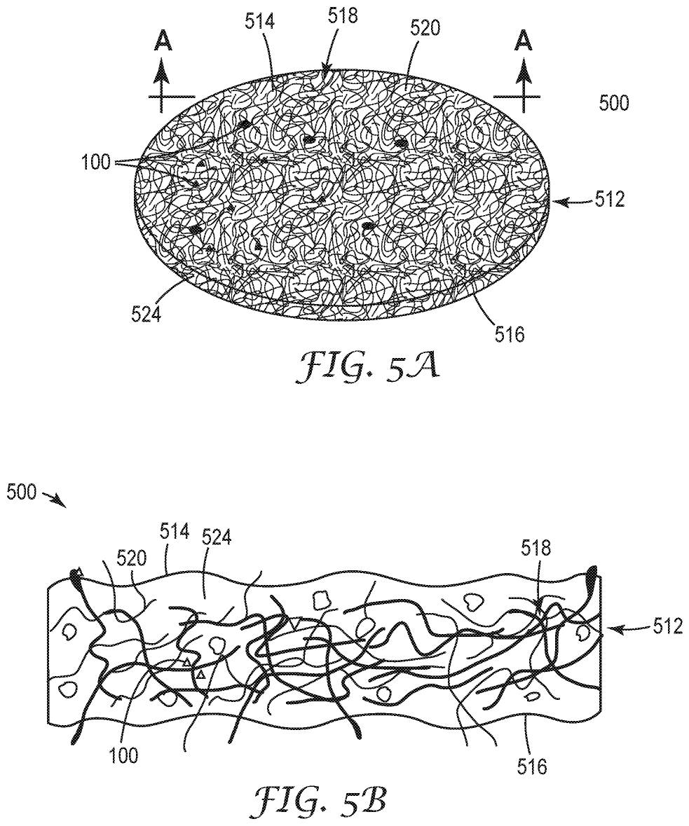

FIGS. 5A and 5B show an embodiment where the abrasive article is a fibrous abrasive article. FIG. 5A is a perspective view of fibrous abrasive article 500. FIG. 5B is a sectional view of the abrasive article of FIG. 5A taken along section line A-A. FIGS. 5A and 5B show substantially the same components and are discussed concurrently. As shown in FIGS. 5A and 5B, fibrous abrasive article 500 includes a nonwoven web 512. Nonwoven web 512 includes first major surface 514 and opposite second major surface 516. Each of first major surface 514 and second major surface 516 have an irregular or substantially non-planar profile. Nonwoven web 512 includes fiber component 518, which includes individual fibers 520. Soft shaped abrasive particles 100 are dispersed throughout nonwoven web 512 and binder 524 adheres soft shaped abrasive particles 100 to the individual fibers. Although soft shaped abrasive particles 100 are shown, fibrous abrasive article 500 can include any other shaped abrasive particle descried herein.

In other embodiments of fibrous abrasive articles, the nonwoven web may be at least partially embedded into a surface of a support. Supports may include a scrim or cloth. In these embodiments, soft shaped abrasive particles 20 may be concentrated towards the surface of the fibrous abrasive article as opposed to being dispersed throughout the article. The support can be attached to or be part of a belt of web.

While not so limited, fiber component 518 can range from about 5 wt % to about 30 wt % of fibrous abrasive article 500, about 10 wt % to about 27 wt %, about 21 wt % to about 27 wt %, about 22 wt % to about 26 wt %, less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, or 30 wt %. Fiber component 518 can include a plurality of individual fibers 520 that are randomly oriented and entangled with respect to each other. Individual fibers 520 are bonded to each other at points of mutual contact. Individual fibers 520 can be staple fibers or continuous fibers. As generally understood, “staple fiber” refers to a fiber of a discrete length and “continuous fiber” refers to a fiber that can be a synthetic filament. Individual fibers 520 can range from about 70 wt % to about 100 wt % of fiber component 18, about 80 wt % to about 90 wt %, less than, equal to, or greater than about 70 wt %, 75, 80, 85, 90, 95, or 100 wt % of fiber component 518.

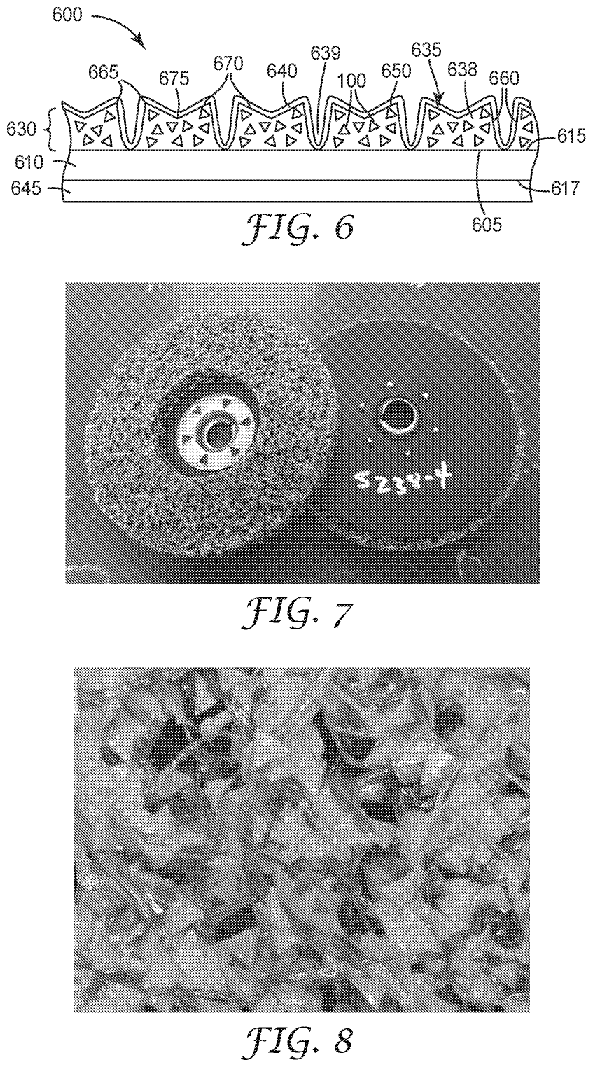

A composite abrasive article is shown in FIG. 6. As shown, composite abrasive article 600 includes backing 610, which has respective first and second major surfaces 615 and 617. Abrasive layer 630 contacts and is secured to first major surface 615. Abrasive layer 630 includes a plurality of shaped abrasive composites 635, each having grinding surface 650, contoured base 605, and walls 660, that are separated by optional contoured channels 639. Each grinding surface 650 independently includes cusps 665, facets 670, and central feature 675. Shaped abrasive composites 635 include soft shaped abrasive particles 100 dispersed in polymeric binder 638. Shaped abrasive composites 635 can further include any blend of soft shaped abrasive particles, such as soft shaped abrasive particles 200A-200E, with soft crushed abrasive particles, ceramic crushed abrasive particles, or mixtures thereof. Optional supersize 640 is disposed on abrasive layer 630 opposite backing 610. Optional attachment interface layer 645 is disposed on second major surface 617. While contoured channels 639 may be essentially devoid of abrasive material as shown in FIG. 6, they may also be covered by a layer (such as a thin layer) of abrasive material.

Any of the soft shaped abrasive particles described herein can be incorporated into any further abrasive article beyond those shown herein. As a further example, soft shaped abrasive particles 100 or 200A-200E can be incorporated in a polymeric extrudate that forms a bristle of an abrasive brush.

One reason to include soft shaped abrasive particles 100 or 200A-200E in any of the abrasive articles described herein is that soft shaped abrasive particles 100 or 200A-200E, may allow for the abrasive articles to have a selective abrasive performance. For example, if the abrasive articles described herein are used on a workpiece including a plurality of materials, the abrasive article may be configured to abrade at least one material of a workpiece while abrading substantially less of or none of the other material. This may be due to the hardness of soft shaped abrasive particles 100 or 200A-200E, the specific shape of soft shaped abrasive particles 100 or 200A-200E, or a combination thereof.

As an example of a method of using an abrasive article including soft shaped abrasive particles 100 or 200A-200E, the abrasive article can be contacted with a workpiece that includes two or more layers of different materials. In an embodiment in which a hardness of the first material of the workpiece is less than a hardness of the second material of the workpiece, a hardness of shaped abrasive particles 100 or 200A-200E may be higher than a hardness of the first layer but less than a hardness of the second layer. More specifically, about 50% to about 100% of soft shaped abrasive particles 100 or 200A-200E can have a hardness greater than the first layer but less than the second layer, or 90% to about 100%, or less than, equal to, or greater than about 50%, 55, 60, 65, 70, 75, 80, 85, 90, 95, or about 100%. As a result of the hardness of soft shaped abrasive particles 100 or 200A-200E, relative to the first and second layers, upon movement of one of the abrasive article and the workpiece, the first layer will be substantially more abraded than the second layer. In some embodiments, the second layer may be free of abrasion.

In some embodiments, that first layer of material can be a relatively soft material contacting a harder second layer of material. The first layer, for example, can include a material such as a cured polymeric material, an organic deposit, an inorganic deposit, a biological material, or a mixture thereof. The second material can include a relatively harder material than the first material such as a metallic material (e.g., aluminum, iron, copper, nickel, steel, chrome, alloys thereof, or mixtures thereof), a composite, a ceramic, a wood, a plastic, or mixtures thereof.

With respect to the first layer of material, examples of cured polymeric materials can include a layer of paint, a layer of clear coat, a plastic material, an adhesive layer, a film layer, or mixtures thereof. Examples of organic deposits include a layer of food, soap residue, cosmetic residue (e.g., make-up or hair product), charred carbon, carbon deposit, or mixtures thereof. Examples of inorganic deposits include a mineral, a salt, a grout, a caulk, a sealant, an oxide, or mixtures thereof. Examples, of oxides include any binary compound of oxygen and another element or group. Iron oxides such as rust are examples of inorganic deposits. Examples of salts include an inorganic carbonate, an inorganic oxalate, an inorganic sulfate, an inorganic hydroxide, or mixtures thereof. Examples of biological materials include a bacteria, a fungi, or a combination thereof

The workpiece can be any component or portion of an apparatus where it may be desirable to abrade a material. As non-limiting examples, the workpiece may be an aircraft fuselage where the first material is paint or a clear coat and the second material is aluminum. If the paint or clear coat is removed from the fuselage, it may be desirable to not abrade or damage the underlying aluminum. As a further example, if the first material is an organic deposit such as food or soap residue, the abrasive article can be used in household applications to remove the organic deposit from a surface such as a countertop without substantially abrading the material of the countertop. As a further example, if the first layer is an inorganic deposit, the abrasive article can be used in household or industrial applications to remove mineral deposits in pipes without substantially abrading the material of the pipe. As a further example, if the first layer is a biological material, the abrasive article may be used in an abatement procedure to remove mold colonies from an underlying surface such as a wall without substantially abrading the underlying wall. As a further example, if the first layer is paint, the abrasive article can be used to strip the paint from an underlying wood or drywall structure. As yet a further example, if the first layer is wallpaper or an adhesive, the abrasive article can be used to strip the wallpaper, adhesive, or both from an underlying wood or drywall.

The abrasive articles described herein are capable of being tuned to selectively abrade at least one of two materials of a workpiece. In further embodiments, the material and shape of the soft shaped abrasive particles can be further tuned to allow for selective abrasion between three materials or even more materials. For example, the abrasive article can be tuned to abrade two out of three materials of a workpiece or to only abrade one out of three materials of the workpiece.

The abrasive articles described herein can be manufactured according to any suitable method. For example, the abrasive articles can be manufactured by selecting soft shaped abrasive particles having a hardness of a predetermined value to be greater than a material to be abraded but less than the hardness of a second material to be substantially free of abrasion.

The soft shaped abrasive particles can be distributed about any of the bases, whether a backing or a resin, described herein. The soft shaped abrasive particles can be distributed randomly or according to a predetermined pattern. Distributing the soft shaped abrasive particles according to a predetermined pattern can be accomplished by passing the soft shaped abrasive particles through a screen, through a viscous resinous material, or by placing the particles on a soft scrim having cavities configured to receive the individual particles in a predetermined orientation. In embodiments where the base includes is arranged along an x-y plane having a z-axis orthogonal thereto, individual soft shaped abrasive particles can be rotated about the z-axis on the base to achieve a desired z-direction rotational orientation. If present, ceramic shaped abrasive particles can be oriented on the base or backing in a corresponding method. Soft crushed abrasive particles or ceramic crushed abrasive particles can be included in any suitable manner.

### EXAMPLES

Various embodiments of the present disclosure can be better understood by reference to the following Examples which are offered by way of illustration. The present disclosure is not limited to the Examples given herein.

The following unit abbreviations are used to describe the examples:

° C.: degrees Centigrade

cm: centimeter

g/m²: grams per square meter

inch: 1 inch=2.54 centimeter

mm: millimeter

Unless stated otherwise, all reagents were obtained or are available from chemical vendors such as Sigma-Aldrich Company, St. Louis, Mo., or may be synthesized by known methods. Unless otherwise reported, all ratios and percentages are by weight.

In Examples 1-3, the materials are referred to as follows in Table 1:

| Abbreviation | Description |
|---|---|
| F1 | Nylon 6,6 500 denier × 76.2 mm staple fibers, |
| | obtained as “PN100” from Palmetto |
| | Synthetics, LLC, Kingstree, South Carolina |
| F2 | Nylon 70 denier × 53.3 mm staple fibers, from |
| | 3M Company |
| F3 | Nylon 58 denier × 50.8 mm staple fibers, from |
| | 3M Company |
| PU1 | blocked urethane prepolymer, obtained as “ADIPRENE |
| | BL16” from Chemtura Corporation, Middlebury, |
| | Connecticut |
| PU2 | blocked urethane prepolymer, obtained as “ADIPRENE |
| | BL31” from Chemtura Corporation, Middlebury, |
| | Connecticut |
| CUR | aromatic amine curative, obtained as “RAC-9907” |
| | from Royce international, East Rutherford, New Jersey |
| PMA | propylene glycol monomethyl ether, obtained as |
| | “DOWANOL PMA” from Dow Chemical Company, |
| | Midland, Michigan |
| PR | a 25M solution of phenoxy resin in 1-methoxy-2- |
| | acetopropane, obtained as “INCHEMREZ PKHS” |
| | from InChem Corp, Rock Hill, South Carolina |
| OS | organosilane, obtained as “XIAMETER OFS-6040 |
| | SILANE” from Dow Chemical Corporation, Midland, |
| | Michigan |
| CaCO₃ | calcium carbonate, obtained as “HUBERCARB Q325” |
| | from Huber Engineered Materials, Quincy, Illinois |
| LiSt | lithium stearate, obtained as “LIC 17” from |
| | Baerlocher USA, Cincinnati, Ohio as a 44.1% dispersion |
| | in PMA |
| ASIL1 | amorphous silica, obtained as “AEROSIL R202” from |
| | Evonik Degussa Corporation USA, Parsippany, New Jersey |
| ASIL2 | amorphous silica, obtained as “CAB-O-SIL M-5” from |
| | Cabot Corporation, Cambridge, Massachusetts |
| XYL | xylene, obtained from Toledo Refining Company, LLC, |
| | Parsippany, New Jersey |
| BENT | bentonite clay, obtained as “VOLCLAY 325” from |
| | American Colloid Company, Arlington Heights, Illinois |
| CB | carbon black, obtained as “RAVEN 16 POWDER” |
| | from Columbian Chemicals Corporation, Marietta, Georgia |
| SURF1 | surfactant, obtained as “TERGITOL XJ” from the |
| | Dow Chemical Corporation, Midland, Michigan |
| SURF2 | surfactant, obtained as “TERGITOL 15-S-40” from |
| | Dow Chemical Corporation, Midland, Michigan |
| THICK | thickener, obtained as “CARBOPOL EZ3” from the |
| | Lubrizol Corporation, Louisville, Kentucky |
| MIN | shaped particles were prepared according to Example 10. |
| GEO | antifoam agent, obtained as “GEO FM LTX” from |
| | GEO Specialty Chemicals, Ambler, Pennsylvania |

### Example 1

A lofty, random air-laid web, having a blend of 90% F1 and 10% F2 at a weight of approximately 677 g/m², was formed using an equipment such as that available under the trade designation “RANDO WEBBER” of Rando Machine Company of Macedon, N.Y. The web was further needle punched in a needle loom, rolled, and a prebond coating having the composition set forth in Table 1 was applied to the air-laid fabric to achieve a dry add-on weight of approximately 274 g/m². The prebond was then cured in an oven. A make coat precursor having the composition set forth in Table 1 was applied at a dry add-on weight of approximately 579 g/m² to the pre-bonded air-laid web. Shaped Urea Formaldehyde particles, MIN, were applied to the uncured make coat precursor at an add-on weight of approximately 347 g/m² to each side of the make coated web via a particle dropper. The abrasive-coated web was then cured in an oven. A size coat precursor of the composition shown in Table 1 was applied to the abrasive coated web to provide a dry size coat add-on weight of approximately 420 g/m² and the size coat precursor was subjected to a final cure in an oven. FIG. 7 is a photograph of the instant fibrous abrasive article. FIGS. 8 and 9 are photographs of the fibrous abrasive article magnified at 20× and 50× respectively.

TABLE 2
Mixes of Examples 1-3

| | Prebond | Make Coat | Size Coat |
|---|---|---|---|
| Material | Coating | Precursor | Precursor |
| XYL | — | 18.9% | — |
| PU1 | 36.8% | 51.3% | 11.5% |
| PU2 | — | — | 11.5% |
| CUR | 13.5% | 18.8% | 9.6% |
| PMA | 20.3% | — | 12.2% |
| PR | 22.0% | — | — |
| OS | 0.8% | 1.1% | — |
| CaCO₃ | 5.1% | — | — |
| LiSt | — | — | 2.9% |
| ASIL1 | 1.5% | — | — |
| ASIL2 | — | 1.4% | — |
| GEO | 0.1% | — | — |
| CB | — | 0.1% | — |
| BENT | — | 8.4% | — |
| SURF1 | — | — | 0.6% |
| SURF2 | — | — | 0.6% |
| THICK | — | — | 0.2% |
| Water | — | — | 51.0% |

### Example 2

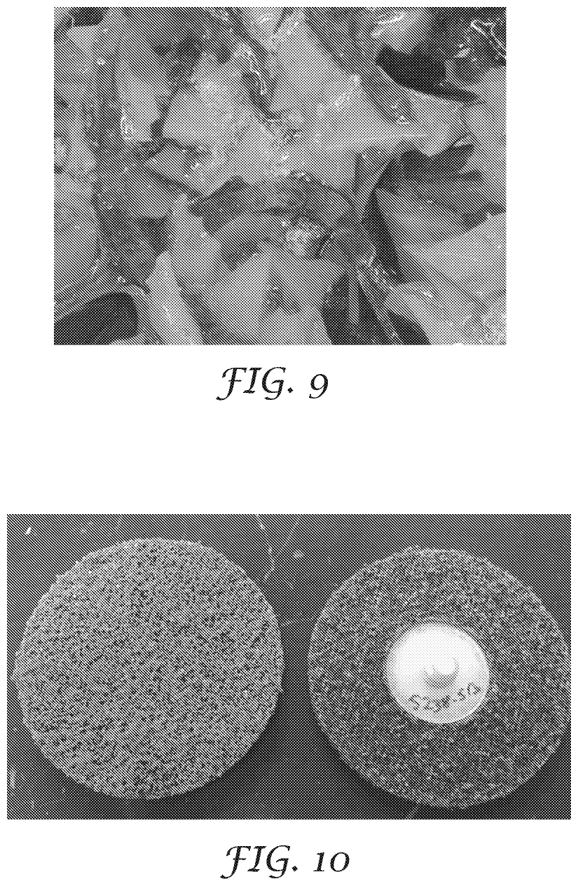

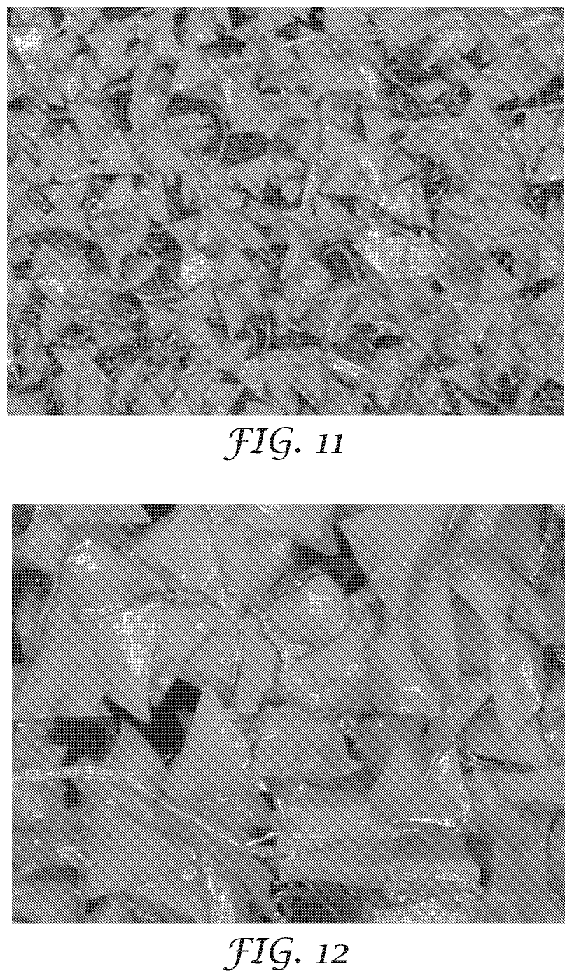

A lofty, random air-laid web, of F3 at a weight of approximately 293 g/m², was formed using a “RANDO WEBBER” equipment. The web was further needle punched into a scrim in a needle loom, rolled, and a make coat precursor having the composition set forth in Table 1 was applied at a dry add-on weight of approximately 290 g/m² to the air-laid fabric. Shaped urea formaldehyde particles, MIN, were applied to the uncured make coat precursor at an add-on weight of approximately 323 g/m² to the top side of the make coated web via a particle dropper. The abrasive-coated web was then cured in an oven. A size coat precursor of the composition shown in Table 1 was applied to the abrasive coated web to provide a dry size coat add-on weight of approximately 258 g/m² and the size coat precursor was subjected to a final cure in an oven. FIG. 10 is a photograph of the instant fibrous abrasive article. FIGS. 11 and 12 are photographs of the fibrous abrasive article magnified at 20× and 50× respectively.

### Example 3

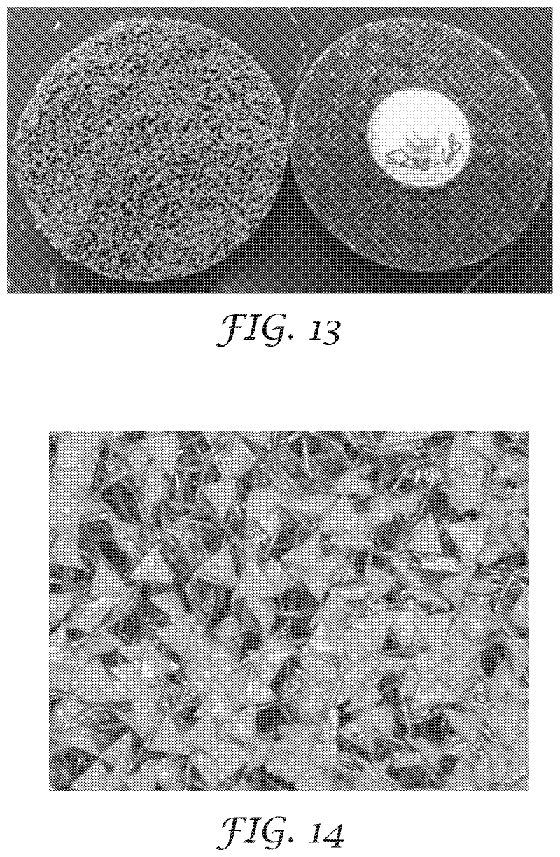

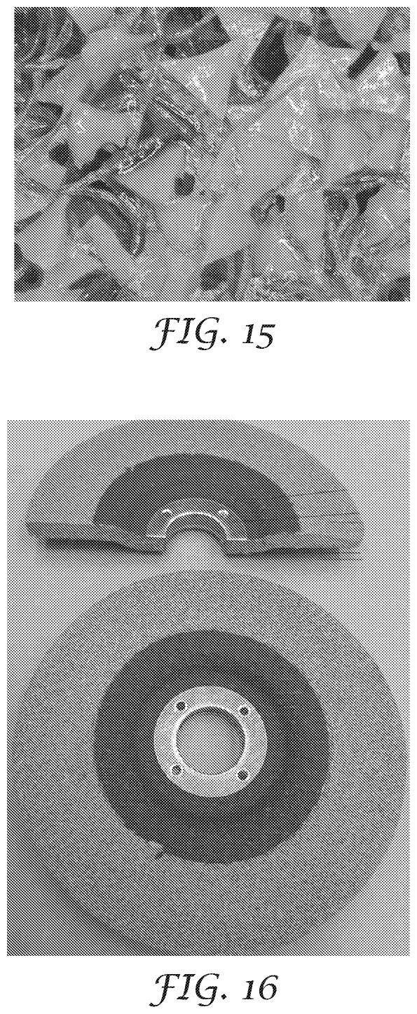

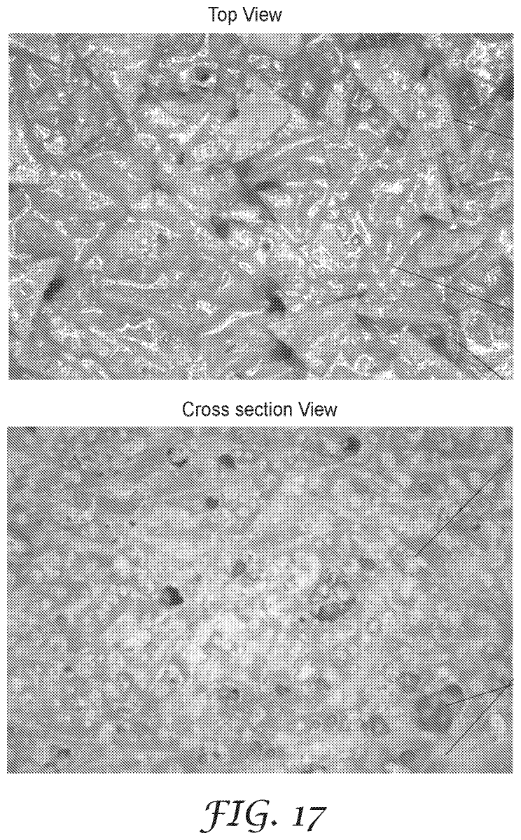

An air laid needled non-woven fabric weighing approximately 798 g/m² commercially available from 3M Company as 3M SCOTCH-BRITE SURFACE CONDITIONING DISC A CRS but without the slurry coat was further coated with a make coat precursor having the composition set forth in Table 1 applied at a dry add-on weight of approximately 355 g/m² to the air-laid, punched, and coated fabric. Shaped urea formaldehyde particles, MIN, were applied to the uncured make coat precursor at an add-on weight of approximately 226 g/m² to the top side of the make coated web via a particle dropper. The abrasive-coated web was then cured in an oven. A size coat precursor of the composition shown in Table 1 was applied to the abrasive coated web to provide a dry size coat add-on weight of approximately 246 g/m² and the size coat precursor was subjected to a final cure in an oven. FIG. 13 is a photograph of the instant fibrous abrasive article. FIGS. 14 and 15 are photographs of the fibrous abrasive article magnified at 20× and 50× respectively.

### Example 4

Mixes of Example 4 were prepared according to the amounts and components listed in Table 3. Mix 1, Mix 2 and Mix 3 were prepared by hand mixing for 5 minutes of the components in the Ziploc plastic bag. Mix 3 was prepared by hand mixing for 5 minutes a combination of Mix 1 and Mix 2.

TABLE 3
Mixes of Example 4

| | AMOUNT IN GRAMS | | | |
|---|---|---|---|---|
| COMPONENT | Mix 1 | Mix 2 | Mix 3 | |
| MIN | 200 | | | Shaped particles prepared |
| | | | | according to Example 10 |
| Liquid phenolic | 33 | | | PREFERE 825136G1” from |
| resin | | | | Dynea Oy Corporation, |
| | | | | Helsinki, Finland |
| Phenolic resin | | 70 | | “VARCUM 29302” from |
| powder | | | | Durez Corporation, Dallas, |
| | | | | Texas |
| sodium | | 70 | | “CRYOLITE” from Freebee, |
| hexafluoroaluminate | | | | Ullerslev, Denmark) |
| Mix I | | | 225 | |
| Mix 2 | | | 140 | |

A Type 27 depressed-center composite grinding wheel was prepared as follows. A aluminum ring was added to the die follow a 5-inch diameter disc of fiber glass style 166 available from Industrial polymers and chemicals Inc. in Shresbury Mass. USA was placed into a 5 inch diameter cavity die. Mix 3 (90 grams) was spread out evenly. A second 3-inch diameter of fiber glass was placed on top of Mix 3 then the second aluminum ring. The filled cavity mold was then pressed at a pressure of 40 tons/38 square inches.

The resulting wheel was removed from the cavity mold and placed on a spindle between depressed center aluminum plates in order to be pressed into a Type 27 depressed-center grinding wheel. The wheel was compressed at 5 ton/38 square inches (1.8 megapascals) to shape the disc. The wheel was then placed in an oven to cure for 3 hours at 90 degrees Celsius (° C.), 5 hours at 120° C., 10 hours at 150° C., and a stop to let the oven cool down. The dimensions of the final wheel were 125 millimeter diameter×7 millimeter thickness. The center hole was ⅞ inch (2.2 centimeters) in diameter. FIG. 16 is a photograph of the instant bonded abrasive article. FIG. 17 is a photograph of the instant bonded abrasive article taken at 20×.

In Examples 5-7, components of the articles and coatings are listed in Tables 4 and 5.

TABLE 4
Binder Resin and Size Coat Binder Resin Components

| | Thermosetting | Size coat |
|---|---|---|
| | binder resin | binder resin |
| Component | (components | (components |
| Description | in wt %) | in wt %) |
| AMSCO RES 5900, | 82% | — |
| available from Unocal, | | |
| El Segundo, California | | |
| USA | | |
| ANTIFOAM Q-2, | 0% | — |
| available from Dow | | |
| Corning, Midland, | | |
| Michigan, USA | | |
| DAP Solution (30%) | 1% | — |
| GEMTEX SC-85-P, | 0% | — |
| available from | | |
| Innospec Performance | | |
| Chemicals, Salisbury, | | |
| North Carolina | | |
| CYMEL 303 LF, | 14% | — |
| available from Allnex | | |
| USA Inc., Alpharetta, | | |
| Georgia, USA | | |
| SUN BLUE | 0% | — |
| PIGMENT BHD-6015, | | |
| available from Sun | | |
| Chemical Corporation, | | |
| Parsippany, New | | |
| Jersey, USA | | |
| SUN WHITE | 3% | — |
| PIGMENT WHD- | | |
| 9507, available from | | |
| Sun Chemical | | |
| Corporation, | | |
| Parsippany, New | | |
| Jersey, USA | | |
| PU 6150, Solvent free | — | 100% |
| aliphatic polycarbonate | | |
| polyurethane | | |
| dispersion, available | | |
| from Alberdingk Boley | | |
| Gmbh Krefeld, | | |
| Germany | | |

TABLE 5
Abrasive Article Components

| | |
|---|---|
| MIN | Shaped particles were prepared according to the |
| | disclosure of U.S. Pat. No. 8,142,531 (Adefris et |
| | al.). The shaped particles were prepared by |
| | molding urea formaldehyde in equilateral triangle- |
| | shaped polypropylene mold cavities. After drying |
| | and curing, the resulting shaped abrasive particles |
| | were about 0.68 mm (side length) × 0.15 mm thick. |
| RPU | A reticulated polyurethane foam available under |
| | the trade designation PU 6150, Solvent free |
| | aliphatic polycarbonate polyurethane dispersion, |
| | available from Alberdingk Boley Gmbh Krefeld, |
| | Germany, of the Woodbridge Group, Mississauga, |
| | Ontario, Canada. |
| OCPU | An open cell polyurethane foam available under |
| | the trade designation HYDROPHILIC POLYURETHANE |
| | FOAM, from the Rogers Foam Corporation, |
| | Somerville, Massachusetts |
| Staple Fiber | A size 17 dtex (15 denier) polyethylene terephthalate |
| | (PET) staple fiber available from Stein Fibers, LTD, |
| | Albany New York. |
| Melty Fiber | A 17 dtex (15 denier) melty fiber available under |
| | the trade designation POLYESTER LMF 937A, of the |
| | Huvis Corporation, Gangnam-gu, South Korea. |

### Example 5

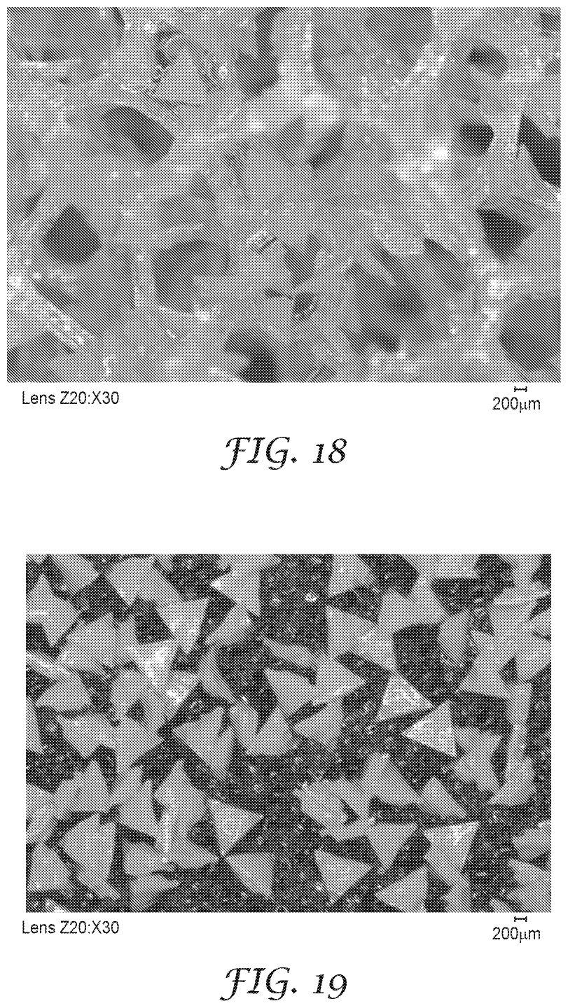

A reticulated polyurethane foam based abrasive article was prepared according to the following description. RPU of Table 5 was impregnated with a thermosetting binder resin of Table 4 using a standard two-roll coater to achieve a dry coating weight of approximately 145 gsm. MIN particles of Table 5 were applied to the uncured thermosetting binder resin at an add-on weight of approximately 140 gsm to the surface of the make coated web via a particle dropper to form an abrasive-coated web. The abrasive-coated web was then cured in an oven at 162.7° C. A size coat binder resin of Table 4 was applied to the abrasive coated web to provide a dry size coat add-on weight of approximately 145 gsm and the size coat binder resin of Table 4 was subjected to a final cure in an oven at 162.7° C. FIG. 18 is a photograph of the reticulated polyurethane foam based abrasive article of Example 5.

### Example 6

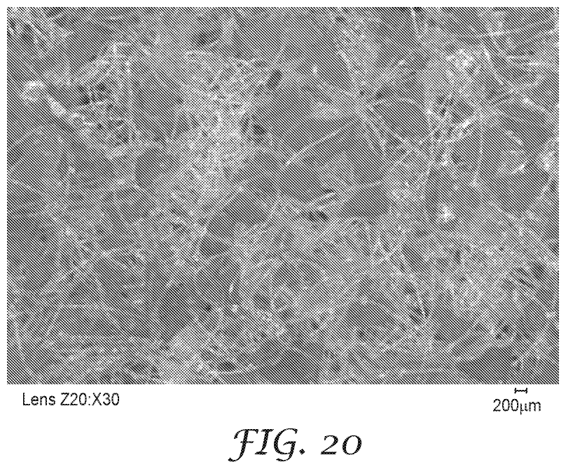

An open cell polyurethane foam based abrasive article was prepared according to the following description. OCPU foam of Table 5 was impregnated with a thermosetting binder resin system of Table 4 using a standard two-roll coater to achieve a dry coating weight of approximately 145 gsm. MIN particles of Table 5 were applied to the uncured thermosetting binder resin at an add-on weight of approximately 140 gsm to the surface of the make coated web via a particle dropper to form an abrasive-coated web. The abrasive-coated web was then cured in an oven at 162.7° C. A size coat binder resin of Table 4 was applied to the abrasive coated web to provide a dry size coat add-on weight of approximately 145 gsm and the size coat binder resin of Table 4 was subjected to a final cure in an oven at 162.7° C. FIG. 19 is a photograph of the open cell polyurethane foam based abrasive article of Example 6.

### Example 7

A lofty nonwoven web based abrasive article was prepared according to the following description. The web was formed from a blend of 80% by weight staple fiber of Table 5 and 15% by weight melty fiber of Table 5. The nonwoven web was formed on a conventional air-laying web forming machine trade designation “RANDO WEBBER” of Rando Machine Company of Macedon, N.Y. The basis weight of the nonwoven web was approximately 170 grams per square meter (gsm). The nonwoven web was then passed through the oven having a temperature ranging from 132.2-137.7° C. The nonwoven web was then impregnated with a thermosetting binder resin system of Table 4 using a standard two-roll coater to achieve a dry coating weight of approximately 145 gsm. MIN particles of Table 5 were applied to the uncured binder resin at an add-on weight of approximately 20 gsm to the surface of the make coated web via a particle dropper to form an abrasive-coated web. The abrasive-coated web was then cured in an oven at 162.7° C. A size coat binder resin of Table 4 was applied to the abrasive-coated web to provide a dry size coat add-on weight of approximately 145 gsm and the size coat precursor was subjected to a final cure in an oven at 162.7° C. FIG. 20 is a photograph of the lofty nonwoven web based abrasive article of Example 7.

### Example 8

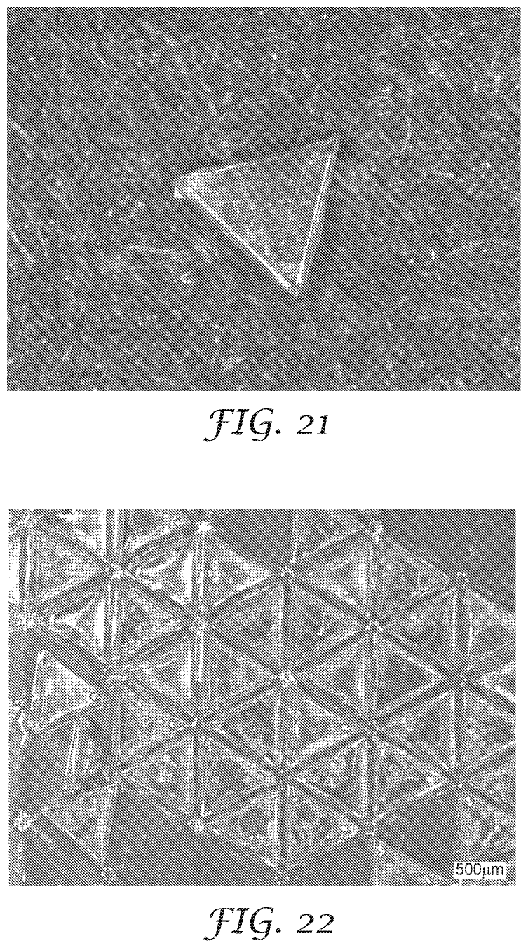

Soft shaped abrasive particles were made according the following procedure. Trimethylolpropane triacrylate, obtained under trade designation SARTOMER 351 of Sartomer Americas, Exton, Pa. mixed with 1% a-amino ketone photoinitiator, obtained under trade designation IGRACURE 369 of BASF, Florham Park, N.J. was coated into a polypropylene tooling and then placed (filled side up) on an aluminum support plate, a layer of polyethylene release film (obtained from Loparex Inc., Cary, N.C.) was applied to the top of the filled tool cavities, and a quartz panel was placed on the release film. The assembly was exposed to a UV light source used to cure the Trimethylolpropane triacrylate. The tool containing the cured composition was then passed under an ultrasonic horn to dislodge the cured shaped particle. FIG. 21 is a photograph of a soft shaped abrasive particle produced according to Example 8 and FIG. 22 is a photograph of a plurality of the shaped abrasive particles according to Example 8 disposed in tool cavities according.

### Example 9

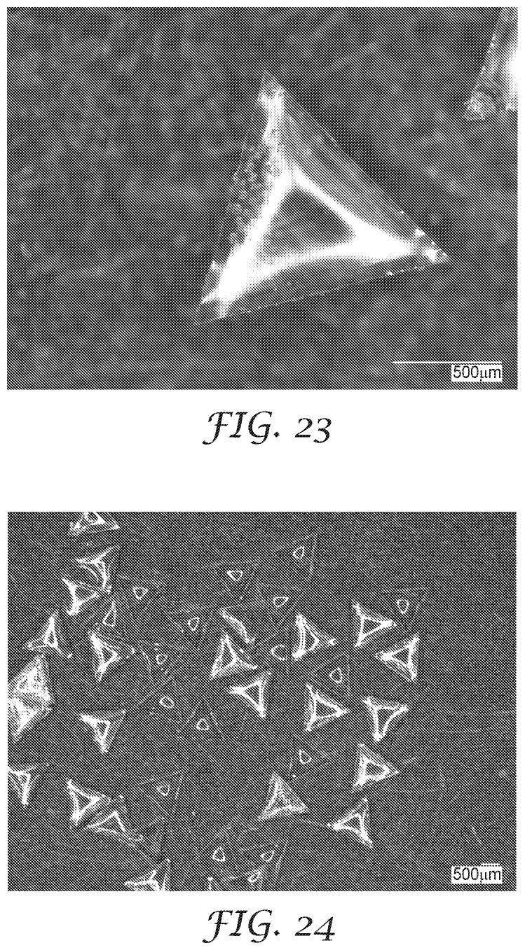

Soft shaped abrasive particles were made according to the following procedure. A resole phenol-formaldehyde resin, 75 wt. % in water, (a 1.5:1 to 2.1:1 (Formaldehyde:Phenol) condensate catalyzed by 1 to 5% metal hydroxide and obtained from Georgia-Pacific, Atlanta, Ga.) coated into a polypropylene tooling and cured at 87.8° C. for 100 minutes, followed by 12 hours at 102.8° C. The assembly was exposed to a UV light source used to cure the resin. The tool containing the cured composition was then passed under an ultrasonic horn to dislodge the cured shaped particle. FIG. 23 is a photograph of a soft shaped abrasive particle produced according to Example 6 and FIG. 24 is a photograph of a plurality of the shaped abrasive particles according to Example 8 disposed in tool cavities. In FIGS. 21-24 the reflective visual artifact is caused by internal reflection in the soft shaped abrasive particles.

### Example 10

Soft shaped abrasive particles designated MIN were prepared by mixing the ingredients of Table 6 sequentially into a rigid plastic container while mixing with a laboratory air stirrer mixer commercially available from INDCO Inc, New Albany Indiana under model number AS15D. The prepared solution was then placed into a pressure pot under a pressure in range of 2-10 PSI and extruded through a slot die onto a micro-replicated tooling having equilateral triangle-shaped polypropylene mold cavities that were previously coated with a release agent. The tooling and the mixture was passed through an oven ranging from 93° C. to 121° C., which resulted in curing the mixture within the tooling. The tooling with the cured mixture was then passed through a sonicating horn to remove the cured mixture from the tooling cavities. After drying and curing, the resulting shaped abrasive particles were about 0.68 mm (side length)×0.15 mm thick.

TABLE 6
ingredients of MIN

| | Wet | Dry |
|---|---|---|
| Ingredient | Weight % | Weight % |
| Liquid Urea Formaldehyde Resin B3, a | 75 | 77.8 |
| thermosetting urea formaldehyde resin | | |
| available from Acrlin, North Bay Ontario | | |
| Canada | | |
| Rhoplex GL-618, an acrylic resin | 15 | 11.5 |
| available from DOW Chemical | | |
| Company, Midland, Michigan | | |
| MINSTRON 353 Talc, an antifoaming | 5 | 8.0 |
| agent available from Imerys | | |
| TalcAmerica, Inc., Three Forks, Montana | | |
| XIAMETER AFE 1520, an antifoaming | 1 | 0.3 |
| agent available from DOW Chemical | | |
| Company, Midland, Michigan | | |
| Acrylic polymer dispersion | 1 | 0.7 |
| Orange Dye EXP 188-126, a pigment | 1 | 0.8 |
| available from Sun Chemical | | |
| Corporation, Parsippany, New Jersey | | |
| Diammonium Phosphate Food Grade, a | 2 | 1.0 |
| catalyst available from Innophos | | |
| Holdings, Inc., Cranbury New Jersey. | | |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 provides an abrasive article comprising:
a base; and
a plurality of soft shaped abrasive particles distributed about the base.

Embodiment 2 provides the abrasive article of Embodiment 1, wherein one or more of the soft shaped abrasive particles comprises a reaction product of a polymerizable mixture including one or more polymerizable resins.

Embodiment 3 provides the abrasive article of Embodiment 2, wherein the one or more polymerizable resins are chosen from a phenolic resin, a urea formaldehyde resin, a urethane resin, a melamine resin, an epoxy resin, a bismaleimide resin, a vinyl ether resin, an aminoplast resin, an acrylate resin, an acrylated isocyanurate resin, an isocyanurate resin, an acrylated urethane resin, an acrylated epoxy resin, an alkyd resin, a polyester resin, a dying oil, and mixtures thereof.

Embodiment 4 provides the abrasive article of any one of Embodiments 2-3, wherein the polymerizable mixture further comprise at least one of a plasticizer, an acid catalyst, a cross-linker, a surfactant, a mild abrasive, a pigment, a catalyst, and an antibacterial agent.

Embodiment 5 provides the abrasive article of Embodiment 4, wherein the polymerizable resin is in a range of from about 35 wt % to about 100 wt % of the polymerizable mixture.

Embodiment 6 provides the abrasive article of any one of Embodiments 4 or 5, wherein the polymerizable resin is in a range of from about 40 wt % to about 95 wt % of the polymerizable mixture.

Embodiment 7 provides the abrasive article of any one of Embodiments 4-6, wherein the cross-linker is in a range of from about 2 wt % to about 60 wt % of the polymerizable mixture.

Embodiment 8 provides the abrasive article of any one of Embodiments 4-7 wherein the cross-linker is in a range of from about 5 wt % to about 10 wt % of the polymerizable mixture.

Embodiment 9 provides the abrasive article of any one of Embodiments 4-8, wherein the mild abrasive is in a range of from 5 wt % to about 65 wt % of the polymerizable mixture.

Embodiment 10 provides the abrasive article of any one of Embodiments 4-9, wherein the mild abrasive is in a range of from 10 wt % to about 20 wt % of the polymerizable mixture.

Embodiment 11 provides the abrasive article of any one of Embodiments 4-10, wherein the plasticizer is in a range of from 5 wt % to about 40 wt % of the polymerizable mixture.

Embodiment 12 provides the abrasive article of any one of Embodiments 4-11, wherein the plasticizer is in a range of from 10 wt % to about 15 wt % of the polymerizable mixture.

Embodiment 13 provides the abrasive article of any one of Embodiments 4-12, wherein the acid catalyst is in a range of from 1 wt % to about 20 wt % of the polymerizable mixture.

Embodiment 14 provides the abrasive article of any one of Embodiments 4-13, wherein the acid catalyst is in a range of from 5 wt % to about 10 wt % of the polymerizable mixture.

Embodiment 15 provides the abrasive article of any one of Embodiments 4-14, wherein the surfactant is in a range of from 0.001 wt % to about 15 wt % of the polymerizable mixture.

Embodiment 16 provides the abrasive article of any one of Embodiments 4-15, wherein the surfactant is in a range of from 0.5 wt % to about 10 wt % of the polymerizable mixture.

Embodiment 17 provides the abrasive article of any one of Embodiments 4-16, wherein the antimicrobial agent is in a range of from 1 wt % to about 5 wt % of the polymerizable mixture.

Embodiment 18 provides the abrasive article of any one of Embodiments 4-17, wherein the antimicrobial agent is in a range of from 10 wt % to about 15 wt % of the polymerizable mixture.

Embodiment 19 provides the abrasive article of any one of Embodiments 4-18, wherein the pigment is in a range of from 0.1 wt % to about 10 wt % of the polymerizable mixture.

Embodiment 20 provides the abrasive article of any one of Embodiments 4-19, wherein the pigment is in a range of from 3 wt % to about 5 wt % of the polymerizable mixture.

Embodiment 21 provides the abrasive article of any one of Embodiments 1-20, further comprising a plurality of ceramic shaped abrasive particles.

Embodiment 22 provides the abrasive article of any one of Embodiments 1-21, wherein at least a portion of the soft shaped abrasive particles are tetrahedral soft shaped abrasive particles.

Embodiment 23 provides the abrasive article of Embodiment 22, wherein the tetrahedral soft shaped abrasive particles comprise four faces joined by six edges terminating at four vertices, each one of the four faces contacting three of the four faces, and a major portion of the tetrahedral abrasive particles have at least one of the vertices oriented in substantially the same direction.

Embodiment 24 provides the abrasive article of any one of Embodiments 22 or 23, wherein at least one of the four faces is substantially planar.

Embodiment 25 provides the abrasive article of any one of Embodiments 22-24, wherein at least one of the four faces is concave.

Embodiment 26 provides the abrasive article of any one of Embodiments 22-25, wherein all of the four faces are concave.

Embodiment 27 provides the abrasive article of any one of Embodiments 22-26, wherein at least one of the four faces is convex.

Embodiment 28 provides the abrasive article of any one of Embodiments 22-27, wherein all of the four faces are convex.

Embodiment 29 provides the abrasive article of any one of Embodiments 22-28, wherein at least one tetrahedral abrasive particle has equally-sized edges.

Embodiment 30 provides the abrasive article of any one of Embodiments 22-29, wherein at least one tetrahedral abrasive particle has different-sized edges.

Embodiment 31 provides the abrasive article of any one of Embodiments 22-30, wherein a length of the edges independently ranges from about 0.5 μm to about 2000 μm.

Embodiment 32 provides the abrasive article of any one of Embodiments 22-31, wherein a length of the edges independently ranges from about 150 μm to about 200 μm.

Embodiment 33 provides the abrasive article of any one of Embodiments 22-32, wherein a radius of curvature of the vertices independently ranges from about 0.5 μm to about 80 μm.

Embodiment 34 provides the abrasive article of any one of Embodiments 1-21, wherein at least a portion of the soft shaped abrasive particles are triangular soft shaped abrasive particles.

Embodiment 35 provides the abrasive article of Embodiment 34, wherein the triangular shaped abrasive particles independently comprise a first side and a second side separated by a thickness, each comprising a triangular geometric shape.

Embodiment 36 provides the abrasive article of Embodiment 35, wherein the triangular geometric shape is independently chosen from a right triangle, an equilateral triangle, a scalene triangle, an isosceles triangle, an acute triangle, and an obtuse triangle

Embodiment 37 provides the abrasive article of Embodiment 35, further comprising a sidewall connecting the first side and the second side.

Embodiment 38 provides the abrasive article of Embodiment 37, wherein the sidewall is a sloping sidewall.

Embodiment 39 provides the article of any one of Embodiments 35-38, wherein the first face and the second face are substantially parallel to each other.

Embodiment 40 provides the article of any one of Embodiments 35-39, wherein the first face and the second face are substantially non-parallel to each other.

Embodiment 41 provides the abrasive article of any one of Embodiments 35-40, wherein at least one triangular shaped abrasive particles has equally-sized edges terminating in vertices.

Embodiment 42 provides the abrasive article of any one of Embodiments 35-41, wherein at least one triangular shaped abrasive particles has different-sized edges terminating in vertices.

Embodiment 43 provides the abrasive article of any one of Embodiments 35-42, wherein a length of the edges independently ranges from about 0.5 μm to about 2000 μm.

Embodiment 44 provides the abrasive article of any one of Embodiments 35-43, wherein a length of the edges independently ranges from about 150 μm to about 200 μm.

Embodiment 45 provides the abrasive article of any one of Embodiments 35-44, wherein a radius of curvature of the vertices independently ranges from about 0.5 μm to about 80 μm.

Embodiment 46 provides the abrasive article of any one of Embodiments 35-45, wherein the triangular shaped abrasive particles are distributed over about 10% to about 95% surface area of a first side of the base.

Embodiment 47 provides the abrasive article of any one of Embodiments 35-46, wherein the triangular shaped abrasive particles are distributed over about 10% to about 50% surface area of a first side of the base.

Embodiment 48 provides the abrasive article of any one of Embodiments 35-47, wherein the triangular shaped abrasive particles are randomly distributed on the base.

Embodiment 49 provides the abrasive article of any one of Embodiments 35-48, wherein the triangular shaped abrasive particles are distributed according to a predetermined pattern on the base.

Embodiment 50 provides the abrasive article of any one of Embodiments 1-49, wherein at least one of the soft shaped abrasive particles comprises at least one shape feature comprising: an opening, a concave surface, a convex surface, a groove, a ridge, a fractured surface, a low roundness factor, or a perimeter comprising one or more corner points having a sharp tip.

Embodiment 51 provides the abrasive article of any one of Embodiments 1-50, wherein at least one of the soft shaped abrasive particles comprises an opening.

Embodiment 52 provides the abrasive article of any one of Embodiments 1-51, wherein at least 50% of the soft shaped abrasive particles are rotated about a z-axis passing through each of the soft shaped abrasive particles and the substrate to a predetermined z-direction rotational orientation.

Embodiment 53 provides the abrasive article of any one of Embodiments 1-52, wherein a Mohs hardness of one or more of the soft shaped abrasive particles is less than about 9.

Embodiment 54 provides the abrasive article of any one of Embodiments 1-53, wherein the soft shaped abrasive particles are present in a blend comprising soft crushed abrasive particles, ceramic shaped abrasive particles, ceramic crushed abrasive particles, or mixtures thereof.

Embodiment 55 provides the abrasive article of Embodiment 54, wherein the soft shaped abrasive particles range from about 2 wt % to about 99 wt % of the blend of abrasive particles.

Embodiment 56 provides the abrasive article of Embodiment 54, wherein the soft shaped abrasive particles range from about 15 wt % to about 60 wt % of the blend of abrasive particles.

Embodiment 57 provides the abrasive article of any one of Embodiments 54-56, wherein at least one of the soft shaped abrasive particles and at least one of the soft crushed abrasive particles comprise the same materials.

Embodiment 58 provides the abrasive article of any one of Embodiments 54-57, wherein one or more of the ceramic shaped abrasive particles and the ceramic crushed abrasive particles independently comprise fused aluminum oxide, heat treated aluminum oxide, ceramic aluminum oxide, sintered aluminum oxide, silicon carbide, titanium diboride, boron carbide, tungsten carbide, titanium carbide, diamond, cubic boron nitride, garnet, fused alumina-zirconia, cerium oxide, zirconium oxide, titanium oxide, or a combination thereof.

Embodiment 59 provides the abrasive article of any one of Embodiments 54-58, wherein a Mohs hardness one or more of the ceramic shaped abrasive particles is greater than about 9.

Embodiment 60 provides the abrasive article of any one of Embodiments 1-59, wherein the base is a backing.

Embodiment 61 provides the abrasive article of Embodiment 60, wherein the backing is a flexible backing comprising a polymeric film, a metal foil, a woven fabric, a knitted fabric, paper, a vulcanized fiber, a nonwoven, a foam, a screen, a laminate, or combinations thereof.

Embodiment 62 provides the abrasive article of any one of 1-59, wherein the abrasive article is an abrasive wheel.

Embodiment 63 provides the abrasive article of Embodiment 62, wherein the wheel is a cut-off wheel, a cut-and-grind wheel, a depressed center grinding wheel, a depressed center cut-off wheel, a reel grinding wheel, a mounted point, a tool grinding wheel, a roll grinding wheel, a hot-pressed grinding wheel, a face grinding wheel, or a double disk grinding wheel.

Embodiment 64 provides the abrasive article of any one of Embodiments 62 or 63, wherein the base is an organic binder.

Embodiment 65 provides the abrasive article of any one of Embodiments 62-64, wherein the abrasive wheel comprises:
a first layer comprising a plurality of the soft shaped abrasive particles; and
a second layer spaced apart from the first layer, the second layer comprising at least one of a plurality of the soft shaped abrasive particles, a plurality of the soft crushed shaped abrasive particles, ceramic shaped abrasive particles, ceramic crushed abrasive particles, or mixtures thereof.

Embodiment 66 provides the abrasive article of Embodiment 65, wherein the first layer further comprises a plurality of the soft crushed shaped abrasive particles, ceramic shaped abrasive particles, ceramic crushed abrasive particles, or mixtures thereof.

Embodiment 67 provides the abrasive article of any one of Embodiments 1-59, wherein the base comprises a nonwoven web comprising:
a first irregular major surface and an opposite second irregular major surface; and
a fiber or filament component.

Embodiment 68 provides the abrasive article of Embodiment 67, further comprising a binder dispensed on the fiber or filament component and contacting at least some of the soft shaped abrasive particles, soft crushed abrasive particles, ceramic abrasive particles, or ceramic crushed abrasive particles.

Embodiment 69 provides the abrasive article of any one of Embodiments 67 or 68, wherein the fiber component comprises one or more staple fibers.

Embodiment 70 provides the abrasive article of any one of Embodiments 1-59, wherein the base is an extruded thermoplastic binder.

Embodiment 71 provides the abrasive article of any one of Embodiments 1-59, wherein the base is a backing and the abrasive article is a structured abrasive article comprising:
the backing having first and second opposed major surfaces; and
an abrasive layer disposed on and secured to the first major surface, wherein the abrasive layer comprises shaped abrasive composites, each of the shaped abrasive composites comprising the soft shaped abrasive particles dispersed in a polymeric binder.

Embodiment 72 provides the abrasive article of Embodiment 71, wherein each of the shaped abrasive composites independently comprises:
a contoured base comprising:
   a first end disposed on the backing;
   a second end; and
   a plurality of sidewalls connecting the first end and the second end;
a plurality of walls extending away from the second end of the contoured base, wherein adjacent walls share a common edge, wherein each wall forms a first dihedral angle with the second end of the contoured base of less than or equal to 90 degrees; and
a grinding surface free of contact with the contoured base, wherein the grinding surface comprises:
   a plurality of cusps; and
   a plurality of facets that contact a recessed feature containable within a geometric plane, wherein at least a portion of the recessed feature is disposed closer to the contoured base than is each of the cusps, and wherein each cusp is formed by an intersection of three or more surfaces comprising the walls, the facets, or a combination thereof, wherein at least one of the surfaces is a facet.

Embodiment 73 provides the abrasive article of any one of Embodiments 1-72, wherein the plurality of soft shaped abrasive particles comprises one or more grades of abrasive particles.

Embodiment 74 provides the abrasive article of any one of Embodiments 1-73, wherein the abrasive article is configured to abrade at least one material of a workpiece comprising a first material and a second material that is different than the first material.

Embodiment 75 provides the abrasive article of Embodiment 74, wherein hardness of the first material of the workpiece is less than a hardness of the second material of the workpiece.

Embodiment 76 provides the abrasive article of Embodiment 75, wherein a hardness of about 50% to about 100% of the soft shaped abrasive particles is less than the hardness of the second material of the workpiece.

Embodiment 77 provides the abrasive article of Embodiment 75, wherein a hardness of about 90% to about 100% of the soft shaped abrasive particles is less than the hardness of the second material of the workpiece.

Embodiment 78 provides the abrasive article of any one of Embodiments 74-77, wherein the first material comprises a cured polymeric material, an organic deposit, an inorganic deposit, a biological material, or a mixture thereof.

Embodiment 79 provides the abrasive article of Embodiment 78, wherein the polymeric material comprises paint, a clear coat, plastic, an adhesive, a film, or mixtures thereof.

Embodiment 80 provides the abrasive article of Embodiment 78 wherein the organic deposit comprises food, soap residue, cosmetic residue, charred carbon, carbon deposit, or mixtures thereof.

Embodiment 81 provides the abrasive article of Embodiment 78, wherein the inorganic deposit comprises a mineral, a salt, a grout, or mixtures thereof.

Embodiment 82 provides the abrasive article of Embodiment 81, wherein the salt comprises an inorganic carbonate, an inorganic oxalate, an inorganic sulfate, an inorganic hydroxide, or and mixtures thereof.

Embodiment 83 provides the abrasive article of Embodiment 78, wherein the biological material comprises bacteria, a fungi, or a combination thereof.

Embodiment 84 provides the abrasive article of any one of Embodiments 74-83, wherein the second material comprises a metallic material, a composite, a ceramic, a wood, a plastic, or mixtures thereof.

Embodiment 85 provides the abrasive article of Embodiment 84, wherein the metallic material comprises aluminum, iron, copper, nickel, steel, chrome, alloys thereof, or mixtures thereof.

Embodiment 86 provides a method of using the abrasive article of any one of Embodiments 1-85, the method comprising:

contacting the abrasive article with a workpiece; and

moving at least one of the workpiece and the abrasive article relative to one another.

Embodiment 87 provides the method of Embodiment 86, wherein moving at least one of the workpiece and the abrasive article selectively removes a greater amount of a first material of the workpiece than a second material of the workpiece, that is different than the first material.

Embodiment 88 provides the method of Embodiment 87, further comprising selecting the abrasive article configured to abrade the first material to greater extent than the second material.

Embodiment 89 provides the method of any one of Embodiments 87 or 88, wherein the second material is free of abrasion.

Embodiment 90 provides the method of any one of Embodiments 87-89, further comprising abrading a third material of the workpiece to a greater extent than the second material.

Embodiment 91 provides a method of making the abrasive article of any one of Embodiments 1-90, the method comprising:
selecting soft shaped abrasive particles having a hardness of a predetermined value; and
distributing the soft shaped abrasive particles about the base.

Embodiment 92 provides the method of Embodiment 91, wherein the hardness of the predetermined value is less than at least one material of a workpiece that the abrasive article is configured to abrade.

Embodiment 93 provides the method of any one of Embodiments 91 or 92, further comprising adhering the soft shaped abrasive particles to the base with at least one of a make coat and a size coat.

1. An abrasive article comprising:
a base; and
a plurality of soft shaped abrasive particles distributed about the base, wherein a Mohs hardness of one or more of the soft shaped abrasive particles is less than about 9.

2. The abrasive article of claim 1, wherein one or more of the soft shaped abrasive particles comprises a reaction product of a polymerizable mixture including one or more polymerizable resins.

3. The abrasive article of claim 2, wherein the one or more polymerizable resins are chosen from a phenolic resin, a urea formaldehyde resin, a urethane resin, a melamine resin, an epoxy resin, a bismaleimide resin, a vinyl ether resin, an aminoplast resin, an acrylate resin, an acrylated isocyanurate resin, an isocyanurate resin, an acrylated urethane resin, an acrylated epoxy resin, an alkyd resin, a polyester resin, a dying oil, and mixtures thereof.

4. The abrasive article of claim 1, wherein at least a portion of the soft shaped abrasive particles are tetrahedral soft shaped abrasive particles.

5. The abrasive article of claim 4, wherein an individual tetrahedral shaped abrasive particle includes four faces joined at edges and at least one of the four faces is substantially planar.

6. The abrasive article of claim 5, wherein a length of an individual edge ranges from about 0.5 μm to about 2000 μm.

7. The abrasive article of claim 1, wherein at least a portion of the soft shaped abrasive particles are triangular soft shaped abrasive particles.

8. The abrasive article of claim 7, wherein the triangular shaped abrasive particles independently comprise a first side and a second side separated by a thickness, each comprising a triangular geometric shape.

9. The article of claim 7, wherein the first face and the second face are substantially parallel to each other.

10. The abrasive article of claim 7, wherein a length of an edge of an individual triangular soft shaped abrasive particle edges independently ranges from about 0.5 μm to about 2000 μm.

11. (canceled)

12. The abrasive article of claim 1, wherein the soft shaped abrasive particles are present in a blend comprising soft crushed abrasive particles, ceramic shaped abrasive particles, ceramic crushed abrasive particles, or mixtures thereof.

13. The abrasive article of claim 12, wherein the soft shaped abrasive particles range from about 2 wt % to about 99 wt % of the blend of abrasive particles.

14. The abrasive article of claim 1, wherein the base is a backing.

15. The abrasive article of claim 1, wherein the abrasive article is an abrasive wheel.

16. The abrasive article of claim 1, wherein the base comprises a nonwoven web comprising:
a first irregular major surface and an opposite second irregular major surface; and
a fiber or filament component.

17. The abrasive article of claim 1, wherein the base is a backing and the abrasive article is a structured abrasive article comprising:
the backing having first and second opposed major surfaces; and
an abrasive layer disposed on and secured to the first major surface, wherein the abrasive layer comprises shaped abrasive composites, each of the shaped abrasive composites comprising the soft shaped abrasive particles dispersed in a polymeric binder.

18. The abrasive article of claim 1, wherein the abrasive article is configured to abrade at least one material of a workpiece comprising a first material and a second material that is different than the first material.

19. The abrasive article of claim 18, wherein hardness of the first material of the workpiece is less than a hardness of the second material of the workpiece.

20. A method of using the abrasive article of claim 1, the method comprising:
contacting the abrasive article with a workpiece; and
moving at least one of the workpiece and the abrasive article relative to one another.
